(19) United States
(12) Patent Application Publication
(10) Pub. No.: US 2002/0106804 A1
(43) Pub. Date: Aug. 8, 2002

(54) Method for analyzing reaction test sample using test sample chip

(75) Inventor: Koji Tanaka, Aichi-ken (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NIPPON LASER & ELECTRONICS LAB, Nagoya-shi (JP)

(21) Appl. No.: 09/863,981

(22) Filed: May 23, 2001

(30) Foreign Application Priority Data
Feb. 5, 2001 (JP) 2001/27731
Feb. 9, 2001 (JP) 2001/34138

(51) Int. Cl. B01L 3/02

(52) U.S. Cl. 436/54; 436/180; 422/100; 422/103

(57) ABSTRACT

The present provides a method for analyzing a reaction test sample using test sample chips, by which a number of test sample chips can be prepared with fixing test samples of a very slight amount being disposed on each of the test sample chips of substrates at a high density, and detection of reaction test samples can be efficiently carried out with a single operation by using the corresponding test sample chips.

### DETAILED DESCRIPTION OF THE INVENTION

1. Technical Field of the Invention

The present invention relates to a method for analyzing a reaction test sample using a test sample chip, which detects reaction test samples by using a test sample chip on which a number of fixing test samples of polynucleotide and protein such as DNA, RNA are fixed and prepared on a substrate in the form of spots.

2. Background of the invention

A substance such as protein, etc., which is denatured unless it is handled in a water solution and is likely to lose its activation property, is solidified on a substrate such as slide glass, etc., at a high density, and a test sample chip is prepared. At this time, there is a shortcoming in that, in the spotting of a slight amount such as several hundreds of picoliters such as a DNA micro-array, the spotted test sample solution is instantly dried to cause the test sample to lose its activation property and the solidification efficiency on the substance is reduced.

Conventionally, for example, in an operation of protein screening and quantitative measurement such as blood inspection in the field of clinical site, a test sample solution is poured in respective holes of a micro-titer plate (80 mm ×120 mm and 96 holes), and solidification reaction and detection reaction are carried out in a liquid phase. However, the amount of a test sample required for one-time measurement was a great deal such as several tens to hundred microliters in comparison with a DNA micro-array.

Therefore, in the present situation where an analysis is requested with only a very slight amount of a test sample, in an analysis system that requires a great deal of a test sample, there causes a case where no interconnection is secured with other analysis systems.

Also, the number of pieces to be analyzed, which can be carried out per time, is 96, which is insufficient, as represented by the DNA micro-array. In addition, a chip-type solidification substrate to be used, which has a small capacity, such as slide glass, etc., has been demanded.

However, the area occupied by the micro-tier plate remains unchanged to be 80 mm×120 mm as before. Furthermore, in the present situations where an analysis is requested with only a very slight amount of a test sample, the analysis system that needs an amount equivalent to several tens of microliters does not meet the current trend. Also, as has been represented by a DNA micro-array, etc., the number of pieces to be analyzed at one time is 384, which is insufficient.

In addition, when automating by means of machinery, operations requiring manpower are simplified. On the other hand, a suction portion to sample a test sample is repeatedly used by washing it in order to reduce the cubic volume occupied by the entire equipment and costs thereof. Contamination between test samples was unavoidable.

### SUMMARY OF THE INVENTION

The present invention was developed to solve these and other shortcomings as described above, and it is therefore an object of the invention to provide a method for analyzing a reaction test sample using test sample chips, by which a number of test sample chips can be prepared with fixing test samples of a very slight amount being disposed on each of the test sample chips of substrates at a high density, and detection of reaction test samples can be efficiently carried out with a single operation by using the corresponding test sample chips.

It is another object of the invention to provide a method for analyzing a reaction test sample using a test sample chip, in which a number of flow channels to connect suction members, liquid distributing members and suction/discharge actuating members to each other are easily changed over, and a spotting operation of a fixing test sample solution and a reaction test sample solution can be efficiently carried out.

### BRIEF DESCRIPTION OF THE DRAWINGS

FIG. 1 is an explanatory view showing the outline of analyzing apparatus;

FIG. 2 is an explanatory view showing a suction/discharge apparatus;

FIG. 3 is an explanatory view showing a flow-channel changing mechanism;

FIG. 4 is an explanatory view showing a liquid distributing apparatus;

FIG. 5 is a process chart for preparation of a test sample chip and analysis of a reaction test sample;

FIG. 6 is an explanatory view showing a suction state;

FIG. 7 is an explanatory view showing discharge and liquid distributing states;

FIG. 8 is an explanatory view showing a liquid distributing state of a reaction test sample solution with respect to a test sample chip;

FIG. 9 is an explanatory view showing a modified embodiment;

FIG. 10 is an explanatory view showing another modified embodiment; and

FIG. 11 is an explanatory view showing still another modified embodiment.

### EMBODIMENTS OF THE INVENTION

Hereinafter, a description is given of embodiments of the invention with reference to the accompanying drawings.

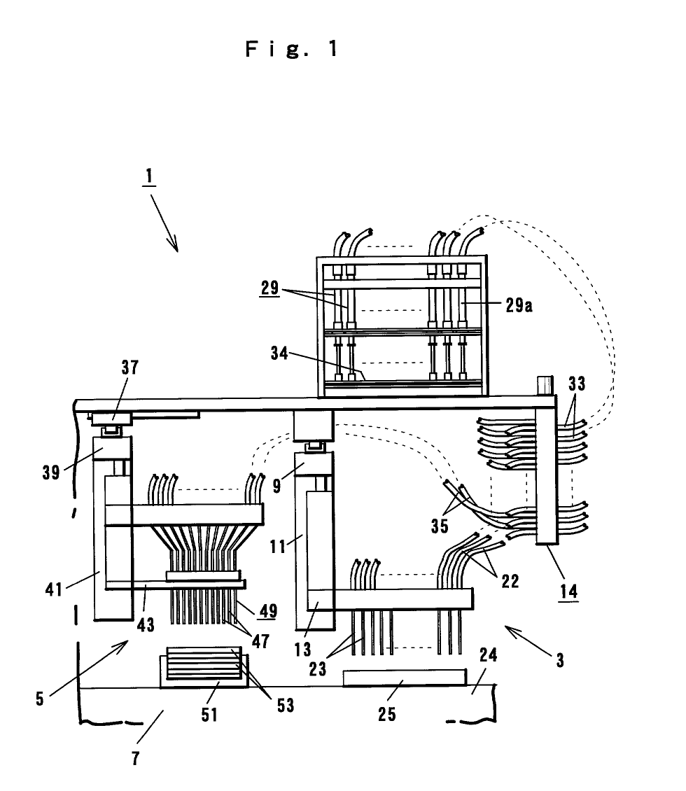

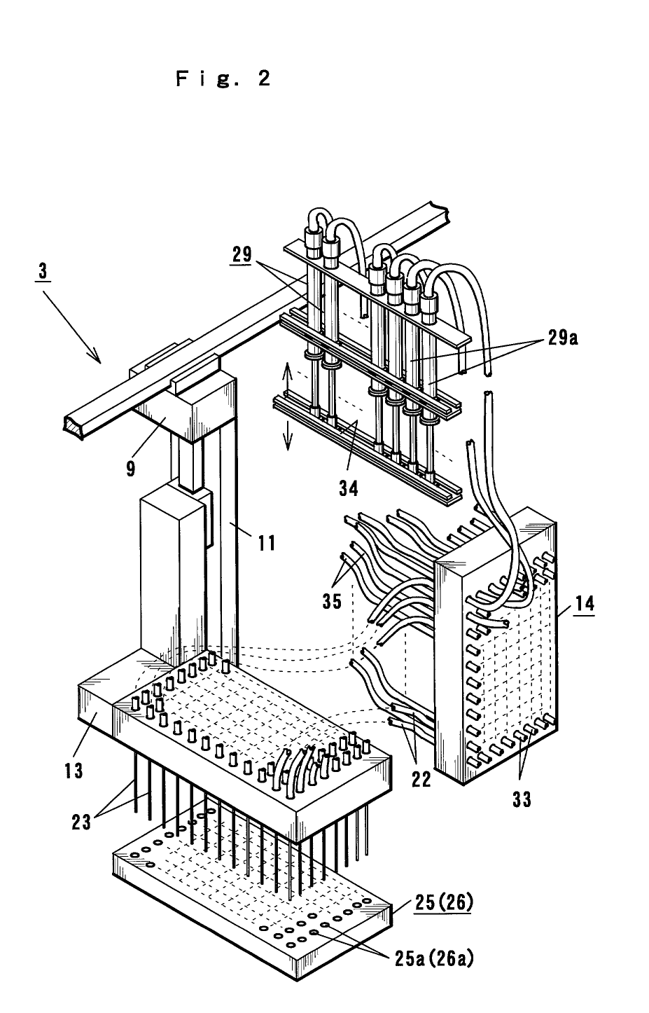

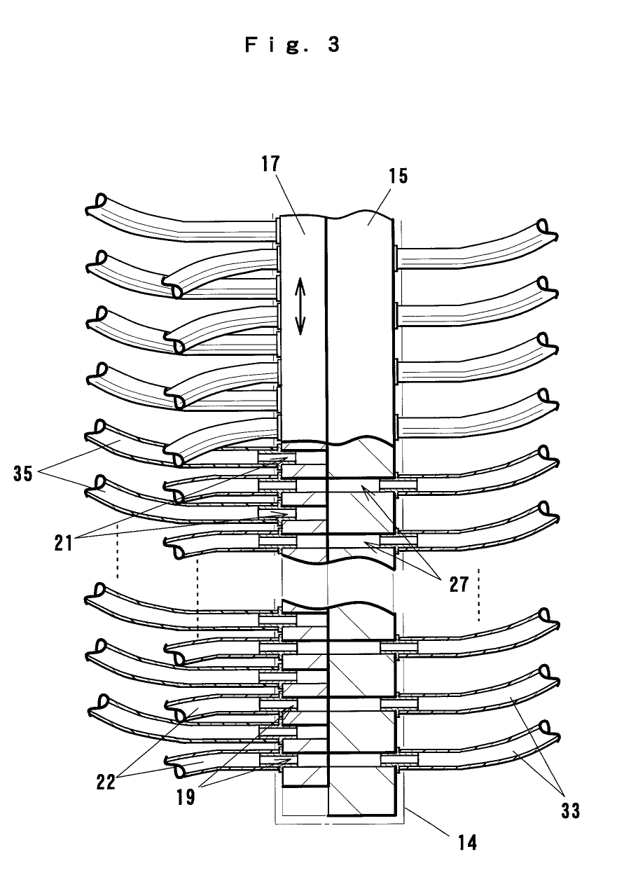

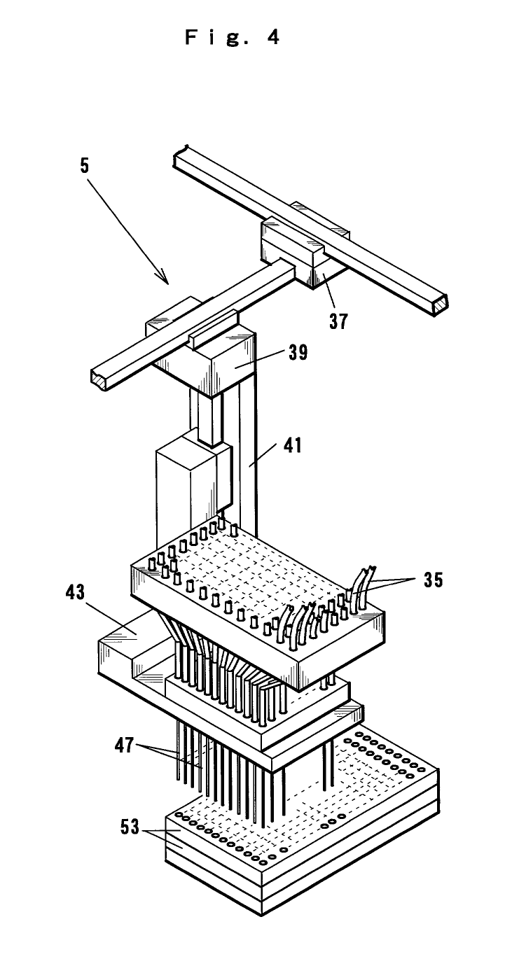

In FIG. 1 through FIG. 4, chip preparing and analyzing equipment 1 comprises a suction/discharge apparatus 3 and a liquid distributing apparatus 5, which are attached to the body frame 7 thereof. The first carriage 9 of the suction/discharge apparatus 3 is supported so as to reciprocate in the forward and backward directions shown in the drawings. The corresponding first carriage 9 is provided with the first vertical frame 11, and the first holder 13 is supported on the corresponding first vertical frame 11 so as to move in the vertical direction. The corresponding first holder 13 is moved in the forward and backward directions and in the vertical direction by a publicly known drive member (not illustrated).

The first holder 13 is provided with a number of suction members 23 consisting of nozzles and needles in the form of an array or a matrix having appointed intervals therebetween so that their tip ends are opposed to a placement base 24 on the body frame 7. The fixing test sample containers 25 and reaction test sample containers 26, which accommodate a fixing test sample are selectively placed on the placement base 24.

The fixing test sample container 25 and reaction test sample container 26 are provided with, for example, 96 reservoirs 25a or 26a described above, opposite to the respective suction members 23. The respective reservoirs 25a of the fixing test sample container 25 store different types or the same type of fixing test sample solution of an appointed amount when preparing test sample chips. Also, the respective reservoirs 26a of the reaction test sample container 26 store the above-described reaction test sample solution of an appointed amount when analyzing protein or polynucleotide, etc., by using the prepared test sample chips.

The fixing test sample solution is adjusted in compliance with test sample chips to be prepared, and is composed of a solution in which polynucleotide and protein of DNA, RNA (DNA pieces, mRNA, cDNA, synthetic DNA and RNA, etc., inherent to a chromosome) is dissolved in, for example, 3×3 SSC solution (0.45M sodium chloride, 0.045M sodium citrate, and which is adjusted to PH:7.00). Also, the reaction test sample solution is composed of a solution in which polynucleotide and protein extracted from an analyte to be analyzed by the prepared test sample chips is dissolved in a 3×3 SSC solution (0.45M sodium chloride, 0.045M sodium citrate, and which is adjusted to PH:7.00).

The body frame 7 is provided with a flow pass changer 14. The flow pass changer 14 is composed of a fixing plate 15 and a changer plate 17 moving in contact with the corresponding fixing plate 15. The fixing plate 15 is provided with a number of suction/discharge ports 27 (96 ports in the case where the number of test samples to be spotted on a substrate 53 is 96) at an appointed interval. The changer plate 17 is provided a number of suction ports 19 and discharge ports 21 so that they are selectively aligned with their respective suction/discharge ports 27. The changer plate 17 reciprocates by an operating member (not illustrated) to cause the respective suction ports 19 and discharge ports 21 to selectively communicate with their suction/discharge ports 27.

In the changer plate 17, the suction ports 19 are connected to the suction members 23 by tubes 22, the discharge ports 21 are connected to liquid distributing members 47 described later by tubes 35, and the suction/discharge portions 27 are connected to the suction/discharge operating members 29 described layer by tubes 33, respectively. The respective suction/discharge operating members 29 are composed of injectors that slidably supports pistons 29b in cylinders 29a. An operating plate 34 is integrally coupled to the piston 29b of the respective suction/discharge operating members 29. The pistons 29b are caused to reciprocate by the corresponding operating plate 34, wherein a test sample solution and a reaction test sample solution are sucked in the cylinder 29a including the tubes 33, and the respective solutions stored therein are discharged.

In detail, the operating plate 34 is moved to an appointed distance so that all the amount of the fixing test sample solution and reaction test sample solution stored in the respective reservoirs 25a and 26a are sucked in, and the respective solutions in the reservoirs 25a and 26a are sucked in the cylinders 29a including the tubes 33. And, the operating plate 34 is minutely moved so that the amount of discharge per time is made very slight, and the respective solutions in the cylinders 29a including the tubes 33 are discharged.

The liquid distributing apparatus 5 is disposed at the left side of the body frame 7 in the drawing. The liquid distributing apparatus 5 is composed of the second carriage 37 movably supported in the left and right directions with respect to the body frame 7 in the drawing, the third carriage 39 movably supported in the forward and backward directions of the corresponding second carriage 37 in the drawing, the second holder 43 movably supported in the vertical direction on the second vertical frame 41 secured on the corresponding third carriage 39, and a number of liquid distributing members 47 (96 members in the above-described case) consisting of liquid distributing needles and nozzles, which are secured on the corresponding second holder 43.

And, the second holder 43 is moved in the three-dimensional directions in line with movement of the second carriage 37 and third carriage 39 by a driving member (not illustrated).

Respective liquid distributing members 47 are disposed in the form of matrix at a minute interval in response to the plane of a substrate 53, wherein the diameter of the tip end side is very small and the base end parts thereof are connected to the respective discharge ports 21 via the tubes 35.

A substrate placement base 51 is provided on the body frame 7 corresponding to the downward of a group of the liquid distributing members 4a in which the liquid distributing members are disposed in the form of matrix. On the substrate placement base 51, a substrate 53 such as slide glass, film, plastic (polyethylene, polypropylene), etc. is disposed so as to be positioned when preparing a test sample chip 55. A preferable example of the substrate 53, slide glass may be listed, in which a thin film 54 of very thin butyl rubber and silicon rubber sheet, etc., having a number of holes 54a opened at intervals agreed with the array intervals of the respective liquid distributing members 47 on the surface thereof is coated. Since a fixing test sample solution is stored in respective holes 54a of the thin film 54, the fixing test sample solution is prevented from being contaminated by each other.

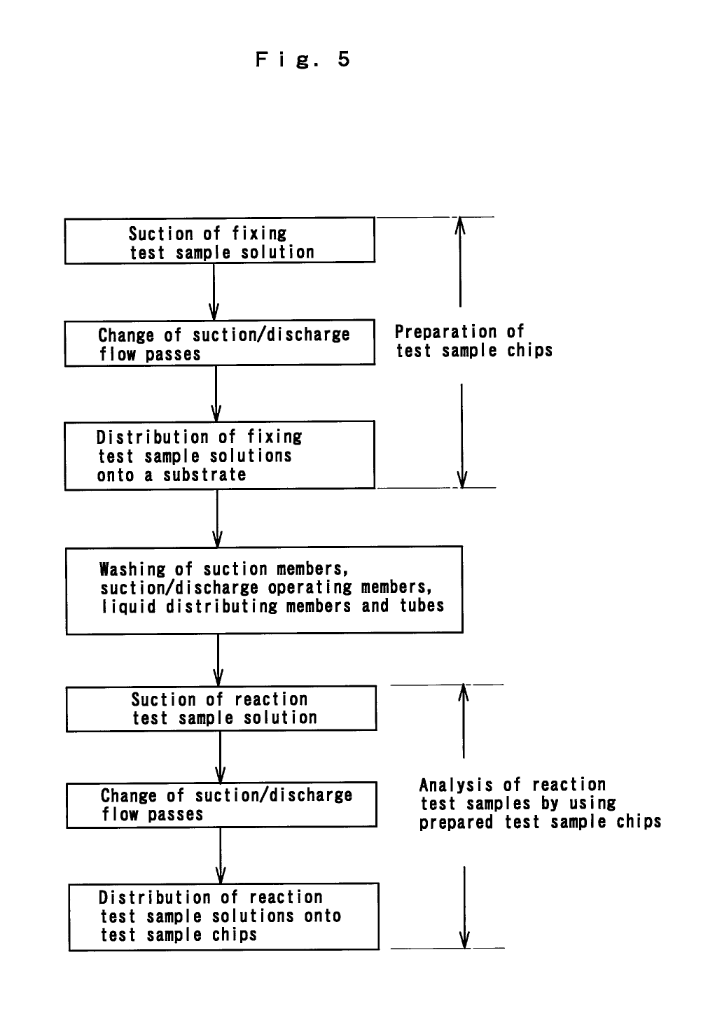

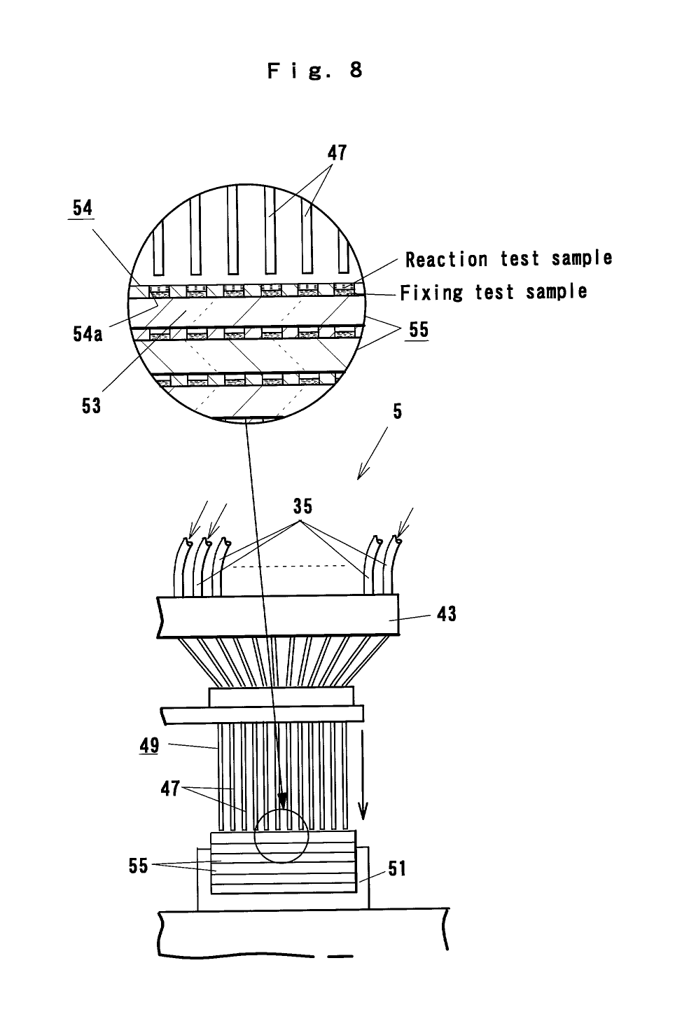

A description is given of a method for preparing test sample chips and analyzing reaction test samples by the chip preparing and analyzing apparatus 1 constructed as described above according to FIG. 5 and FIG. 8.

First, a description is given of the method for preparing test sample chips 55 by spotting a fixing test sample solution on the substrate 53.

The respective suction members 23 are opposed to the respective reservoirs 25a of the fixing test sample container 25 by moving the first carriage 9. And, by moving the second carriage 37 and the third carriage 39, the tip ends of the respective liquid distributing members 47 are opposed to the respective holes 54a of the thin film 54 coated and formed on the uppermost substrate 53 piled in multi-stage in a state where the tip ends are positioned on the substrate placement base 51.

At this time, the changer plate 17 of the suction/discharge apparatus 3 is moved so as to coincide with the suction ports 19 to which the respective suction/discharge portions 27 correspond. Also, as a number of substrates 53 placed on the substrate placement base 51, a number of substrates 51 may be arrayed on a plane in addition to the substrates piled in multi-stage, which are described above.

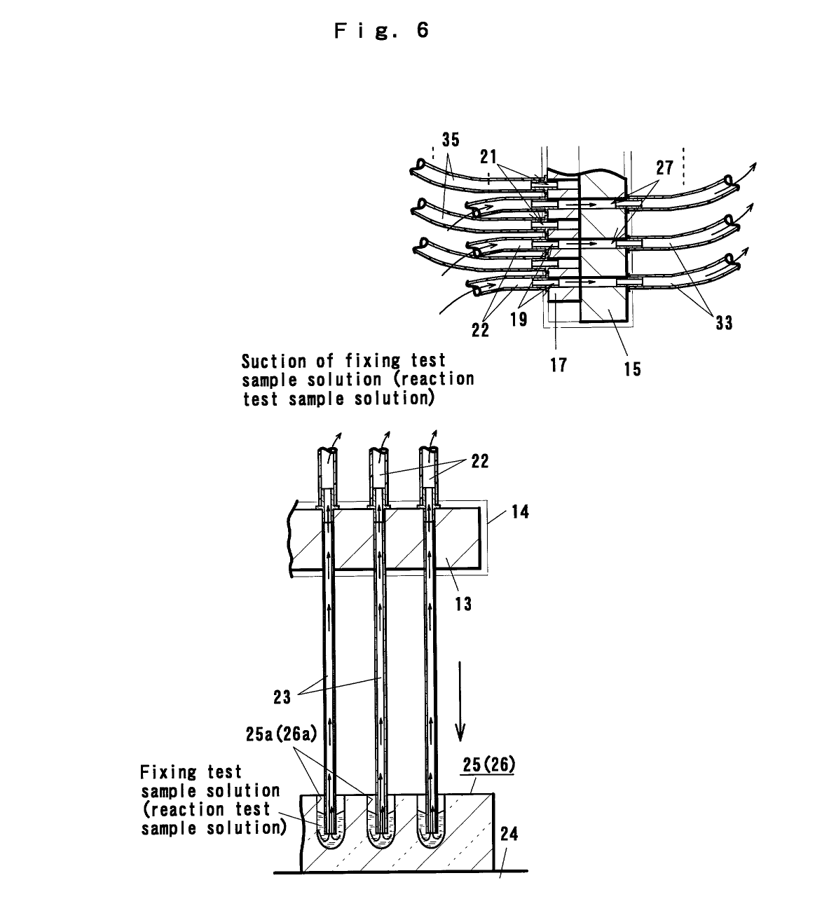

In this state, after the respective tip ends of the respective suction members 23 are caused to sink in the respective reservoirs 25a by lowering the first vertical frame 11, the fixing test sample solution in the reservoirs 25a is sucked in the cylinder 29a including the tubes 33 by operating the operating plate 34 (See FIG. 6).

Next, the respective suction/discharge portions 27 are made coincident with the discharge ports 21 corresponding thereto by returning the changer plate 17. And, the tip ends of the respective liquid distributing members 47 are opposed to the surface of the substrate 53 at minute intervals by controlling and lowering the second vertical frame 41.

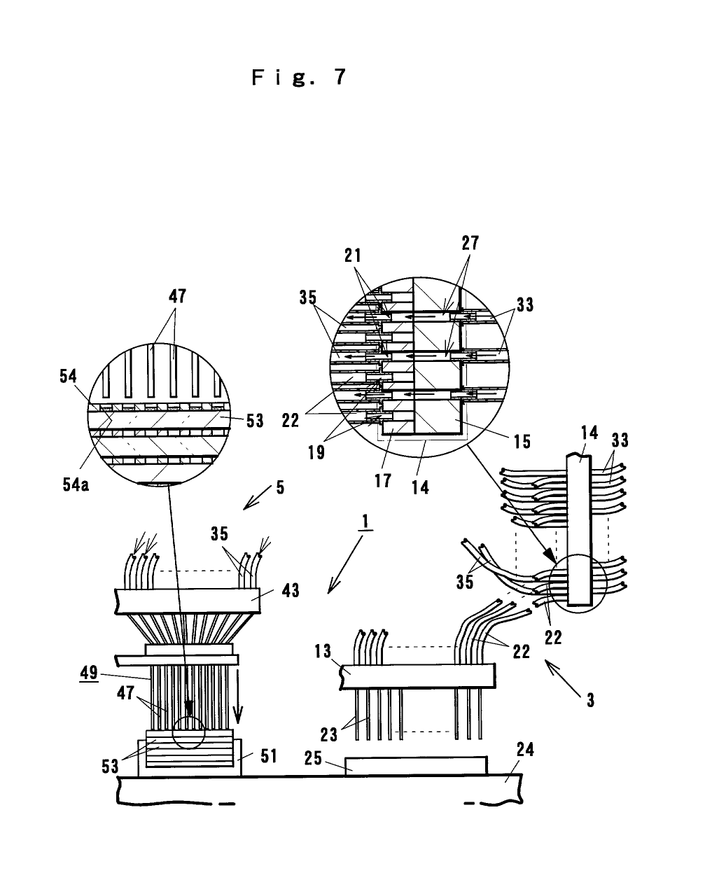

In this state, by moving the operating plate 34 to a very slight distance equivalent to the amount of liquid distribution, the fixing test sample solution stored in the respective tubes 33 and cylinder 29a are spotted from the respective liquid distributing members 47 to the respective holes 54a of the substrate 53 in a very small quantity thereof at one time (See FIG. 7).

In addition, at the beginning of the spotting, it is necessary to spot the test sample solution after completely removing air in the cylinders 29a, tubes 35 and liquid distributing members 47. Therefore, after air is exhausted by setting the movement stroke of the operating plate 34 longer with the amount of air in the tubes 35 and liquid distributing members 47 taken into consideration, the fixing test sample solution may be discharged by minutely moving the operating plate 34 at a stroke subjected to the above-described appointed amount.

Further, after the second vertical frame 41 of the liquid distributing apparatus 5 is returned upwards, the substrate 53 in which the fixing test sample solution is spotted and stored in the respective holes 54a is taken out. After that, again, the second vertical frame 41 is lowered, the tip ends of the respective liquid distributing members 47 are opposed to the respective holes 54a in the substrate 53 on the next stage. And, the fixing test sample solution in the respective holes 54a in the substrate 53 is spotted at one time in an appointed amount by moving the operating plate 34. By repeating the above procedure, it is possible to prepare a number of test sample chips 55 by a single suction operation at one time by spotting the fixing test sample solution on a number of substrates 53 in an appointed amount by a single operation.

In a case where the fixing test sample is fixed with respect to the substrate 53, test sample chips 55 are prepared by a solidification process in which the fixing test sample solution on the surface of the substrate 53 is dried and fixed by irradiating an ultraviolet ray onto the substrate 53, in which the fixing test sample solution is spotted, by, for example, the UV cross linker (made by Hoefer Corporation, UVC500), or by block-processing of the non-spotted areas on the substrate 53 by immersing it in a block solution (for example, succinic anhydride, N-methylpyrosin, sodium borate solution, etc.,).

Next, a description is given of a method for analyzing the reaction test samples by using the test sample chips 55 prepared by the above-described method. Prior to distributing the reaction test same solution to the test sample chips 55, a surplus fixing test sample solution existing in the flow pass changer 14, suction members 23, suction/discharge operating members 29, liquid distributing members 47 and tubes 33 and 35 to connect these to each other is discharged, and the fixing test sample adhered thereto is washed off.

As the washing method, a collection container is placed on the placement base 24 and substrate placement base 51, respectively. In this state, the respective suction/discharge operating members 29 are actuated while changing the respective flow passes by the flow pass changer 14. And, a surplus fixing test sample solution existing in the flow pass changer 14, suction member 23, suction/discharge operating member 29, liquid distributing member 47, and respective tubes 22, 33 and 35 to connected these is discharged from the suction members 23 and liquid distributing members 47 into the collection containers in order to collect the test sample solution.

Next, a suction operation is carried out by the suction/discharge operating members 29 in a state where the liquid distributing members 47 are sunk in a washing solution container (not illustrated) set on the substrate placement base 51. After having sucked the washing solution, the flow pass is changed by the flow pass changer 14, and the washing solution in the suction/discharge operating member 29 is discharged from the suction member 23 into the collection container (not illustrated). By adequately repeating the above-described procedure, the fixing test sample adhered to the flow pass changer 14, suction member 23, suction/discharge operating member 29, liquid distributing member 47, and respective tubes 22, 33, and 35 connected thereto is washed off.

After the washing is carried out by using 0.1% dodecyl sodium sulfide water solution, super pure water, and ethanol in the order as the washing solution, gas-phase suction is then carried out via the liquid distributing member 47, whereby ethanol adhered to the flow pass changer 14, suction member 23, suction/discharge operating member 29, liquid distributing member 47, and respective tubes 22, 33 and 35 connected thereto is dried.

After the washing has been completed, the reaction test sample container 26 in which a reaction test sample solution is stored on the respective reservoirs 26a thereof is set on the placement base 24. After that, as described above, by operating the suction/discharge operating member 29 for suction in a state where the suction members 23 are sunk in the respective reservoirs 26a, the reaction test sample solution is stored in the cylinder 29 and tube 35. (See FIG. 6).

On the other hand, a plurality of test sample chips 55 that are prepared by the above-described method are set on the substrate placement base 51 in multi-stage or in the form of a plane. After that, by operating the suction/discharge operating member 29 for discharge, the stored reaction test sample solution is discharge in the respective holes 54a of the test sample chips 55 by an appointed amount by the respective liquid distributing members 47, wherein the reaction test sample is reacted with the fixing test sample in order to analyze the reaction test samples (See FIG. 8).

The embodiment enables that a number of fixing test sample solutions are distributed on the substrate 53 by a single operation to prepare test sample chips 55, and the amounts of the fixing test samples at respective spots are made almost uniform, wherein test sample chips are prepared. Also, unevenness of the reaction accuracy among the spots can be minimized.

In addition, it is possible to increase the measurement accuracy by minimizing the unevenness of the liquid distributing amount of the reaction test sample solution with respect to the respective fixing test samples in the prepared test sample chips 55.

A detailed description is given below of modification examples of the flow pass changer.

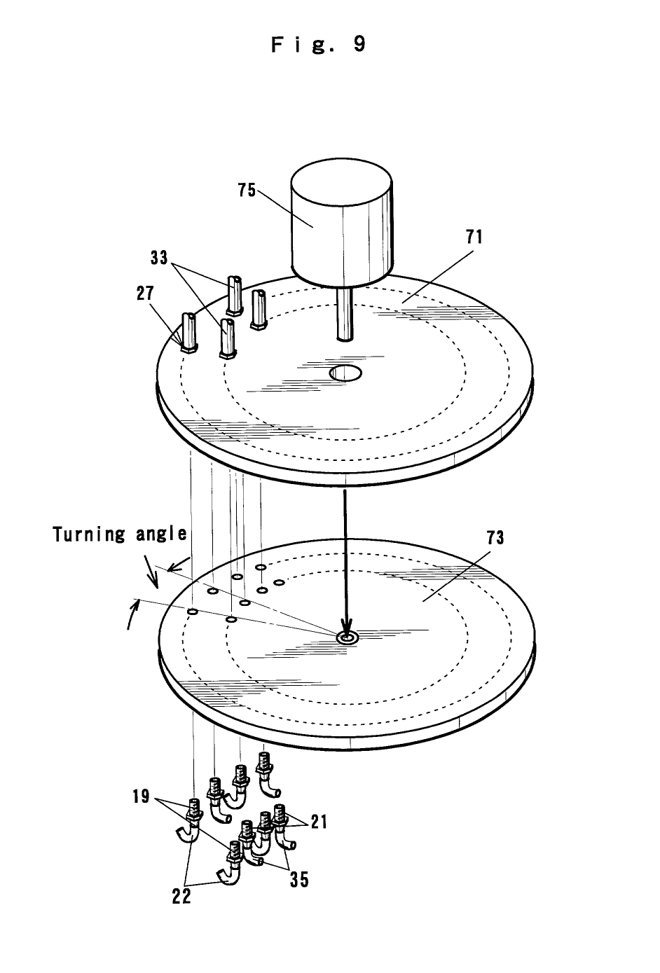

(1) As shown in FIG. 9, the flow pass changer means is composed of a circular disk-shaped fixing disk 71 and changer disk 73. The fixing disk 71 is provided with a number of suction/discharge ports 27 concentrically or in the form of an eddy. Also, a number of suction ports 19 and discharge ports 21 are formed in the changer disk 73 so that they are selectively agreed with the suction/discharge ports 27.

And, the changer disk 73 is turned equivalent to the disposing angle between the above-described suction ports 19 and discharge ports 21 by an electric motor 75. Subsequently, the respective suction/discharge ports 27 of the fixing disk 71 are selectively agreed with the corresponding suction ports 19 and discharge ports 21, whereby the suction/discharge operating member 29 is caused to suck in a test sample solution and a reaction test sample solution, and at the same time the test solution and reaction test sample solution are discharged from the suction/discharge operating member 29.

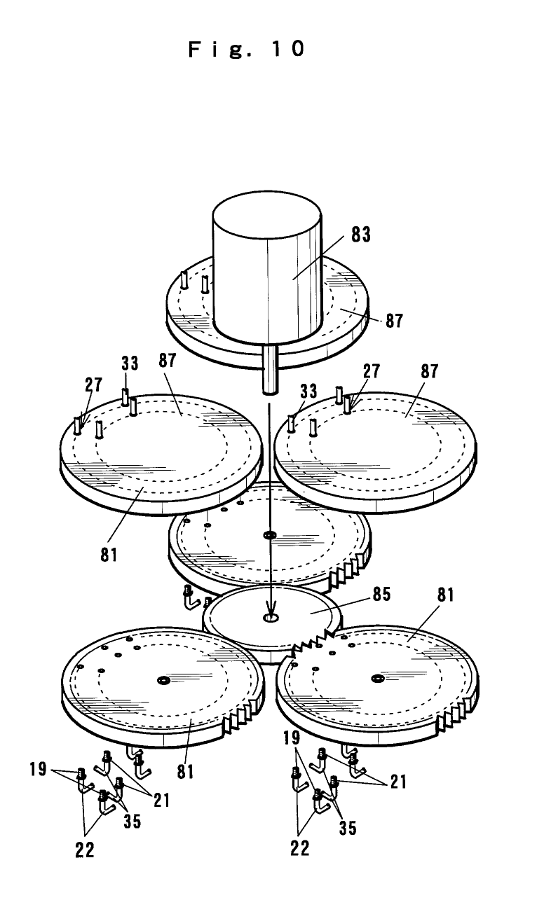

(2) As shown in FIG. 10, at least changer disks 81 that constitute the flow pass changer means are equidistantly disposed concentrically in a plurality (FIG. 10 shows a construction in which three fixing disks and three changer disks are employed).

Teeth (gears) are formed at the outer circumference of the respective changer disks 81. Gears 85 coupled to an electric motor 83 are, respectively, engaged with the respective teeth (gears) to rotate the respective changer disks 81 in the same direction. Fixing disks 87 having a size coincident with the respective changer disks 81 are disposed and brought into close contact with the upper surface of the respective changer disks 81. A number of suction/discharge ports 27 are formed at the respective fixing disks 87 at appointed intervals, and at the same time, a number of suction ports 19 and discharge ports 21 are formed on the respective changer disks 81 so that they are selectively agreed with the respective suction/discharge ports 27.

And, the respective changer disks 81 are turned in line with drive of the electric motor 83 at an angle that is agreed with the interval between the suction port 19 and the discharge port 21. Subsequently, by causing the suction port 19 and discharge port 21 to be selectively agreed with the respective suction/discharge ports 27, suction of a test sample solution and a reaction test sample solution with respect to the suction/discharge operating member 29 and discharge of the respective solutions from the suction/discharge operating member 29 are enabled.

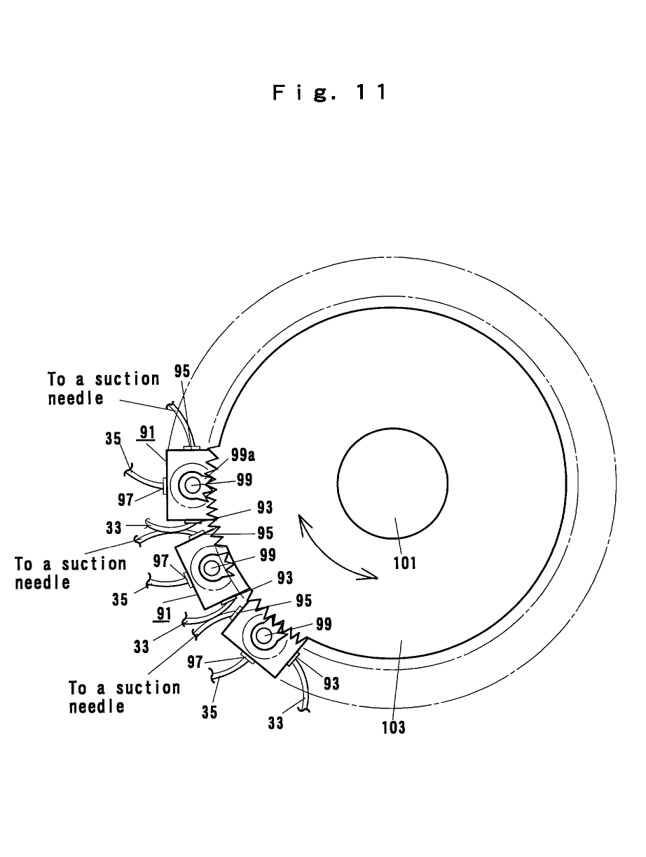

(3) As shown in FIG. 11, respective changer valves 91 of the quantity agreed with the number of spotting are composed so as to have a three-port structure having a suction/discharge port 93, a suction port 95, and a discharge port 97, wherein the suction/discharge port is made common.

Also, each operating shaft 99 by which the connection port is changed over at the respective changer valves 91 is provided with a gear 99a. And, the respective gears 99a are engaged with drive gears 103 coupled to an electric motor 101 so that they can be turned in the same direction.

Subsequently, by turning the respective operating shafts 99 by an appointed angle in line with drive of the electric motor 101, the suction port 95 and discharge port 97 are caused to selectively communicate with the suction/discharge port 93, whereby suction of a test sample solution with respect to the suction/discharge operating member 29, and discharge thereof from the suction/discharge operating member 29 are enabled.

What is claimed is:

1. A method for analyzing a reaction test sample using a test sample chip, comprising the steps of:
preparing a test sample chip by discharge a fixing test sample solution existing in suction/discharge operating means selectively connecting suction members from liquid distributing members into respective holes of thin films covered and formed on a substrate after connecting suction members, liquid distributing members, and suction/discharge operating members, whose quantities are agreed with the number of spotting of a fixing test sample, by means of a flow pass changer means, and sucking respective fixing test sample solutions into said suction/discharge operating members by respective corresponding suction members corresponding thereto;
washing the inside of said liquid distributing members, suction/discharge operating members and suction members by using a washing solution; and
distributing and discharging a reaction test sample solution existing the respective suction/discharge operating member from liquid distributing members onto said respective fixing test samples on a substrate in order to reach the same after selectively connecting a number of suction members, liquid distributing members and suction/discharge operating members, whose quantities are agreed with the number of reaction test sample solutions to be spotted, by a flow pass changer means, and sucking said respective reaction test sample solutions into said suction/discharge operating members by respective suction members.

2. The method for analyzing a reaction test sample using a test sample chip, as set forth in claim 1, wherein said flow pass changer means moves a changer plate, in which connection ports of respective suction flow passes and discharge flow passes are formed with appointed intervals with respect to a fixing plate at which connection ports of the respective suction/discharge flow passes are provided, at a distance that is agreed with the interval between the connection ports of respective suction flow passes and discharge flow passes, and the suction flow passes and discharge flow passes are selectively agreed with respective suction/discharge flow passes.

3. The method for analyzing a reaction test sample using a test sample chip, as set forth in claim 1, wherein said flow pass changer means turns a changer disk, in which connection ports of respective suction flow passes and discharge flow passes are formed with appointed intervals with respect to a fixing disk at which connection ports of the respective suction/discharge flow passes are provided, at an angle that is agreed with the interval between the connection ports of respective suction flow passes and discharge flow passes, and the suction flow passes and discharge flow passes are selectively agreed with respective suction/discharge flow passes.

4. The method for analyzing a reaction test sample using a test sample chip, as set forth in claim 3, wherein said changer disk is composed of a single rotating disk coupled to an electric motor.

5. The method for analyzing a reaction test sample using a test sample chip, as set forth in claim 3, wherein said changer disk causes a plurality of rotating disks to be engaged with a gear to which an electric motor is coupled, and rotates the same in the same direction.

6. The method for analyzing a reaction test sample using a test sample chip, as set forth in claim 1, wherein said flow pass changer means includes changer valves of the quantity which is agreed with the number of flow passes in which connection ports of the suction/discharge flow passes, connection ports of suction flow passes, and connection ports of discharge flow passes are provided, and the respective changer valves are selectively agreed with the respective suction/discharge flow passes, suction flow passes and discharge flow passes.
